(19) United States
(12) Patent Application Publication
(10) Pub. No.: US 2023/0420800 A1
(43) Pub. Date: Dec. 28, 2023

(54) ENERGY STORAGE ELEMENT HAVING A PRISMATIC HOUSING

(71) Applicant: VARTA MICROBATTERY GMBH, Ellwangen Jagst (DE)

(72) Inventors: Edward PYTLIK, Ellwangen (DE); David ENSLING, Ellwangen (DE)

(21) Appl. No.: 18/038,712

(22) PCT Filed: Oct. 26, 2021
(86) PCT No.: PCT/EP2021/079719

§ 371 Date: May 25, 2023

(30) Foreign Application Priority Data
Nov. 27, 2020 (EP) 20210495.6

(51) Int. Cl. H01M 50/434; H01M 10/0525; H01M 50/103; H01M 50/536; H01M 4/66

(52) U.S. Cl. CPC H01M 50/434; H01M 10/0525; H01M 50/103; H01M 50/536; H01M 4/667; H01M 2004/027

(57) ABSTRACT

An energy storage element includes an assembly comprising a plurality of anodes, each respective anode of the plurality of anodes comprising an anode current collector having a main region loaded with a layer of negative electrode material and a free edge strip. The energy storage element further includes a plurality of cathodes, each respective cathode comprising a cathode current collector having a main region loaded with a layer of positive electrode material and a free edge strip. The anodes and the cathodes are stacked and are separated by separators or layers of a solid state electrolyte and the assembly is enclosed in a prismatic housing. The free edge strips of the anode current collectors protrude from one side of the assembly and the free edge strips of the cathode current collectors protrude from another side of the assembly.

### CROSS REFERENCE TO RELATED APPLICATIONS

This application is a U.S. National Phase application under 35 U.S.C. § 371 of International Application No. PCT/EP2021/079719, filed on Oct. 26, 2021, and claims benefit to European Patent Application No. EP 20210495.6, filed on Nov. 27, 2020. The International Application was published in German on Jun. 2, 2022 as WO 2022/111932 under PCT Article 21(2).

### FIELD

The disclosure relates to an energy storage element having a prismatic housing.

### BACKGROUND

Electrochemical cells can convert stored chemical energy into electrical energy by virtue of a redox reaction. They generally comprise a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is ensured by an ion-conducting electrolyte.

If the discharge is reversible, i.e. if it is possible to reverse the conversion of chemical energy into electrical energy that took place during the discharge and thus to charge the cell again, this is said to be a secondary cell. The designation of the negative electrode as anode and the designation of the positive electrode as cathode, which is generally used for secondary cells, refers to the discharge function of the electrochemical cell.

For many applications today, secondary lithium-ion cells are used because they can provide high currents and at the same time are characterized by a comparatively high energy density. They are based on the use of lithium, which can migrate between the electrodes of the cell in the form of ions. The negative electrode and the positive electrode of a lithium-ion cell are often used in the form of so-called composite electrodes, which comprise electrochemically active components as well as electrochemically inactive components.

In principle, all materials that can absorb and release lithium ions can be used as electrochemically active components (active materials) for secondary lithium-ion cells. Carbon-based particles, such as graphitic carbon, are often used for the negative electrode. Other, non-graphitic carbon materials that are suitable for the intercalation of lithium can also be used. In addition, metallic and semi-metallic materials that are alloyable with lithium can also be used. For example, the elements tin, aluminum, antimony, and silicon can form intermetallic phases with lithium. In some embodiments, the negative electrode may also be based on metallic lithium. For example, lithium metal oxides such as lithium cobalt oxide (LiCoO₂) and lithium manganese oxide (LiMn₂O₄), lithium iron phosphate (LiFePO₄) or derivatives thereof may be used as active materials for the positive electrode. The electrochemically active materials are generally contained in particle form in the electrodes.

As electrochemically inactive components, the composite electrodes generally comprise a flat and/or strip-shaped current collector, for example a metallic foil, which serves as a carrier for the respective active material. Generally, the current collector is covered on both sides with a layer of active material. For example, the current collector for the negative electrode (anode current collector) may be formed of copper or nickel and the current collector for the positive electrode (cathode current collector) may be formed of aluminum, for example. Furthermore, the electrodes can comprise an electrode binder (e.g., polyvinylidene fluoride (PVDF) or another polymer, for example, carboxymethylcellulose), conductivity-enhancing additives, and other additives as electrochemically inactive components. The electrode binder ensures the mechanical stability of the electrodes and often the adhesion of the active material to the current collectors.

For the production of secondary lithium-ion cells, the positive and negative electrodes can be combined with one or more separators to form an assembly. Generally, the assembly comprises at least the sequence “positive electrode/separator/negative electrode”. However, the assembly may comprise more than one positive electrode and one negative electrode. For example, it is possible for an assembly to comprise a plurality of positive and negative electrodes in alternating sequence such that adjacent electrodes always have opposite polarity, with a separator disposed between adjacent electrodes in each case. In forming the assemblies, it may be advantageous to join the electrodes and separators together under pressure, optionally by lamination or by means of bonding.

In embodiments of secondary lithium-ion cells with an anode based on metallic lithium, an assembly may also be formed that initially comprises only a current collector in place of a negative electrode. In these cases, it is envisioned that lithium is introduced into the cell via the cathode, for example, and is deposited on the current collector during initial charging.

With the electrodes and the separator(s), the assembly already comprises the main structural components of the cell. In order to convert it into a functional electrochemical cell, it is necessary in most cases to add a liquid electrolyte which impregnates the electrodes and in particular the separator.

Alternatively, it is also possible to arrange a solid state electrolyte in place of the separator between the electrodes during the manufacture of the assembly, which has intrinsic ionic conductivity and does not have to be impregnated with a liquid electrolyte. In this case, the assembly is a functional electrochemical cell immediately after its formation.

The liquid electrolyte generally used for lithium-ion cells is a solution of at least one lithium salt in an organic solvent mixture.

To form a lithium-ion cell with a basic cylindrical shape, ribbon-shaped electrodes and separators can be processed in a winding machine to form a spiral winding. Such a winding fits perfectly into a cylindrical housing.

For some applications, however, energy storage elements with a prismatic housing are required. To produce such energy storage elements, oppositely poled electrodes with a polygonal base can be stacked to form an assembly with a prismatic base shape. Within the stack, oppositely poled electrodes are generally separated from each other by separators or layers of solid state electrolyte so that there is no direct contact between oppositely poled electrodes. For example, a cubic assembly formed of rectangular cells fits perfectly into a corresponding cubic housing. Within the housing, the electrodes can be electrically interconnected. Usually, electrodes with the same polarity are coupled within the housing to a common current conductor, which is either electrically connected to one of the housing parts or is led out of the housing via a corresponding aperture.

For applications in the automotive sector, for e-bikes or also for other applications with high energy requirements such as power tools, energy storage elements with the highest possible energy density are needed that are simultaneously able to be loaded with high currents during charging and discharging. Modern lithium-ion cells can already achieve an energy density of up to 270 Wh/kg. However, this energy density is only considered an intermediate step. The market is already demanding energy storage elements with even much higher energy densities.

However, other factors than energy density alone must be taken into account in the development of improved energy storage elements. Extremely important parameters are the internal resistance of the cells, which should be kept as low as possible to reduce power losses during charging and discharging, and the thermal connection of the electrodes, which can be essential for temperature regulation of the cells. During fast charging of cells, heat buildup can occur in the cells and electrode stacks due to power losses, which can lead to massive thermomechanical and electrochemical stresses. The risk is amplified where the aforementioned common current conductor is coupled to the electrodes, since heating can occur locally at such separate current conductors during charging or discharging. In particular, greater thermomechanical stresses act on the respective electrode immediately in the vicinity of the current conductors than away from the current conductors.

WO 2017/215900 A1 describes cells whose electrodes are ribbon-shaped and are in the form of a winding. The electrodes each have current collectors loaded with electrode material. Oppositely poled electrodes are arranged offset from each other within the electrode-separator assembly, so that longitudinal edges of the current collectors of the positive electrodes protrude from the winding on one side and longitudinal edges of the current collectors of the negative electrodes protrude from the winding on another side. For electrical contacting of the current collectors, the cell has at least one contact element which rests on one of the longitudinal edges in such a way that a line-shaped contact zone is formed. The contact element is connected to the longitudinal edge along the line-shaped contact zone by welding. This makes it possible to electrically contact the current collector and thus also the associated electrode over his/her entire length. This significantly reduces the internal resistance within the cell described. The occurrence of large currents can therefore subsequently be absorbed much better.

### SUMMARY

In an embodiment, the present disclosure provides an energy storage element. The energy storage element includes an assembly comprising a plurality of anodes, each respective anode of the plurality of anodes comprising an anode current collector having a main region loaded with a layer of negative electrode material and a free edge strip, which is not loaded with the negative electrode material, extending along an edge. The energy storage element further includes a plurality of cathodes, each respective cathode comprising a cathode current collector having a main region loaded with a layer of positive electrode material and a free edge strip, which is not loaded with the positive electrode material, extending along an edge. The anodes and the cathodes are stacked and are separated by separators or layers of a solid state electrolyte. In addition, the energy storage element includes a prismatic housing enclosing the assembly and a contact element connected to a set of respective free edge strips by welding or soldering. The set of respective free edge strips including the free edge strips of the anode current collectors of the free edge strips of the cathode current collectors. The free edge strips of the anode current collectors protrude from one side of the assembly and the free edge strips of the cathode current collectors protrude from another side of the assembly.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides a top view of a preferred embodiment of a current collector, which can be part of an electrode of the energy storage element;

FIG. 2 provides a sectional view of the current collector shown in FIG. 1;

FIG. 3 provides a top view of an anode comprising the current collector shown in FIG. 1 and FIG. 2;

FIG. 4 provides a sectional view of the anode shown in FIG. 3;

FIG. 5 provides a top view of a cell manufactured using the anode shown in FIG. 3, which can be part of the assembly of an energy storage element;

FIG. 6 provides a sectional view of the cell shown in FIG. 5;

FIG. 7A provides a top view of a preferred embodiment of an anode of an energy storage element, which has a rectangular base;

FIG. 7B provides a top view of a preferred embodiment of a cathode of an energy storage element, which has a rectangular base;

FIG. 7C provides a top view of an assembly formed using the electrodes shown in FIG. 7A and in FIG. 7B;

FIG. 8 provides a sectional view of a preferred embodiment of an energy storage element having a housing according to the above third preferred embodiment;

FIG. 9 provides a sectional view of a further preferred embodiment of an energy storage element with a housing according to the above first preferred variant; and

FIG. 10 provides a sectional view of a further preferred embodiment of an energy storage element with a housing according to the above first preferred variant, showing details of the structure of the individual cells.

### DETAILED DESCRIPTION

The present disclosure provides energy storage elements with a prismatic housing, which are characterized by an improved energy density compared to the prior art as well as a homogeneous current distribution as far as possible over the entire surface and length of their electrodes, and which at the same time have excellent properties with regard to their internal resistance and their passive heat dissipation capabilities. Furthermore, the energy storage elements should possess an improved manufacturability and safety.

An energy storage element according to a first aspect of the disclosure is characterized by a combination of the following features a. to i.:
a. It comprises a plurality of anodes and cathodes.
b. The anodes each comprise an anode current collector.
c. the anode current collectors each have a main area loaded with a layer of negative electrode material, and a free edge strip extending along an edge of the anode current collector that is not loaded with the negative electrode material.
d. The cathodes each comprise a cathode current collector.
e. The cathode current collectors each have a main area loaded with a layer of positive electrode material, and a free edge strip extending along an edge of the cathode current collector that is not loaded with the positive electrode material.
f. The anodes and the cathodes are stacked and form an assembly, wherein the anodes and the cathodes are separated in the assembly by separators or layers of a solid state electrolyte.
g. The assembly is enclosed in a prismatic housing.
h. The free edge strips of the anode current collectors protrude from one side of the assembly and the free edge strips of the cathode current collectors protrude from another side of the assembly.
i. The energy storage element has at least one metallic contact element connected to the free edge strips of the anode current collectors and/or the free edge strips of the cathode current collectors by welding or soldering.

For clarification, the connection between the metallic contact element and the edge strips of the anode current collectors or the cathode current collectors is a direct one. In the case of welding, the metallic contact element is directly fused with the free edge strips, while in the case of soldering, at most a thin layer of a solder metal is arranged between the metallic contact element and the free edge strips.

Direct connection of the contact element to the current collectors of the electrodes can ensure excellent heat dissipation characteristics, which will be discussed further below.

It is preferred that the energy storage element comprises two metallic contact elements, one of which is connected to the free edge strips of the anode current collectors by welding or soldering and the other is connected to the free edge strips of the cathode current collectors by welding or soldering.

### Preferred Embodiments of the Electrochemical System

In principle, the present disclosure provides energy storage elements regardless of their electrochemical embodiment. In preferred embodiments, however, the energy storage element is designed as a lithium-ion system, i.e. it has electrodes that can absorb and release lithium reversibly. Basically all electrode materials known for secondary lithium-ion cells can therefore be used for the anodes and cathodes comprised by the energy storage element.

Carbon-based particles such as graphitic carbon or non-graphitic carbon materials capable of intercalating lithium, preferably also in particle form, can be used as active materials in the negative electrodes of an energy storage element. Alternatively or additionally, lithium titanate (Li₄Ti₅O₁₂) or a derivative thereof may be included in the negative electrodes, preferably also in particulate form. Furthermore, the negative electrodes may contain as active material at least one material from the group comprising silicon, aluminum, tin, antimony, or a compound or alloy of these materials that can reversibly deposit and remove lithium, for example silicon oxide, optionally in combination with carbon-based active materials. Tin, aluminum, antimony and silicon can form intermetallic phases with lithium. The capacity to absorb lithium exceeds that of graphite or comparable materials many times over, especially in the case of silicon. The metallic lithium-based anodes or anodes consisting of metallic lithium mentioned at the beginning can also be used.

For the positive electrodes of an energy storage element, lithium metal oxide compounds and lithium metal phosphate compounds such as LiCoO₂ and LiFePO₄ are suitable active materials. Furthermore, particularly well suited are lithium nickel manganese cobalt oxide (NMC) with the chemical formula LiNiₓMn_{y}Co_{z}O₂ (where x+y+z is typically 1), Lithium manganese spinel (LMO) with the chemical formula LiMn₂O₄ or lithium nickel cobalt alumina (NCA) with the chemical formula LiNiₓCo_{y}Al_{z}O₂ (where x+y+z is typically 1). Derivatives thereof, for example lithium nickel manganese cobalt alumina (NMCA) with the chemical formula Li_{1.11}(Ni_{0.40}Mn_{0.39}Co_{0.1}Al_{0.05})_{0.89}O₂ or Li₁₊ₓM-O compounds and/or mixtures of said materials can also be used. The cathodic active materials are also preferably used in particulate form.

In addition, the electrodes of an energy storage element preferably contain an electrode binder and/or an additive to improve electrical conductivity. The active materials are preferably embedded in a matrix of the electrode binder, with adjacent particles in the matrix preferably being in direct contact with each other. Conducting agents have the function of elevating the electrical conductivity of the electrodes. Common electrode binders are based, for example, on polyvinylidene fluoride (PVDF), polyacrylate, styrene-butadiene rubber (SBR) or carboxymethyl cellulose. Common conductive agents include carbon black, graphite, graphene, carbon nanofibers, and metal powder.

### Preferred Embodiments of the Separators

The energy storage element preferably comprises separators made of a plastic material which can be permeated by a liquid electrolyte. For this purpose, plastic films with micropores, for example, but also nonwovens, fabrics and other flat structures made of plastic materials that are permeable to a liquid electrolyte can be used. The prerequisite in each case is that the plastic material used has electrically insulating properties. Suitable plastic materials include polyolefins or polyether ketones or polyethylene terephthalate.

Preferably, separators are used that have a thickness in the range from 5 μm to 50 μm.

When using such separators, the energy storage element preferably comprises an electrolyte, for the case of an energy storage element designed as a lithium ion system in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used include lithium tetrafluoroborate (LiBF₄), lithium bis(trifluoromethanesulfonyl)imide (LiTFSI), lithium bis(fluorosulfonyl)imide (LiFSI), and lithium bis(oxalato)borate (LiBOB).

### Preferred Embodiments of the Solid State Electrolyte

The use of the solid state electrolyte layers is particularly advantageous when anodes based on metallic lithium are used.

The solid state electrolyte can be, for example, a polymer solid state electrolyte based on a polymer-conducting salt complex, which is present in a single phase without any liquid component. As a polymer matrix, a polymer solid-state electrolyte can have, for example, polyacrylic acid (PAA), polyethylene glycol (PEG) or polymethyl methacrylate (PMMA). Lithium conducting salts such as lithium bis(trifluoromethane) sulfonyl imide (LiTFSI), lithium hexafluorophosphate (LiPF₆) and lithium tetrafluoroborate (LiBF₄) may be dissolved in these.

If a solid state electrolyte is used, it is advantageous if proportions (e.g. up to 10 percent by weight) of the solid state electrolyte, for example one of the said polymer solid state electrolytes with a conducting salt dissolved therein, are also contained in the anodes and/or the cathodes of the energy storage element.

### Preferred Embodiments of the Separators

In a configuration with separator and liquid electrolyte, the energy storage element preferably has at least one of the immediately following features a. to c.:
a. The separators are polygonal, preferably rectangular, flat structures made of an electrically insulating plastic substrate, in particular in the form of the aforementioned plastic film with micropores or nonwoven, which can be penetrated by a liquid electrolyte.
b. The separators have a thickness in the range from 5 μm to 50 μm, preferably in the range from 10 μm to 30 μm, preferably in the range from 7 μm to 12 μm.
c. The edges of the separators form the sides of the assembly from which the free edge strips of the anode current collectors and the cathode current collectors protrude.

The immediately preceding features a. to c. are preferably realized together.

In a preferred embodiment, the energy storage element has the immediately following feature:

The separators comprise at least one inorganic material, in particular a ceramic material, which improves their resistance to thermal stresses.

This inorganic material protects the separators from shrinkage as a result of local heating, such as can occur when a contact element is welded on. The risk of a short circuit is thus considerably reduced.

The above information regarding the preferred thickness of the separators preferably also refers to the separators including the at least one inorganic material.

In preferred embodiments of the energy storage element, the separators, which comprise the at least one inorganic material for elevation of their resistance, are realized in combination with the current collectors described further below, which comprise an edge region with a support material.

In another preferred further development, the separators are characterized by the immediately following feature a.:
a. The at least one inorganic material is contained in the separators as particulate filler material.

In preferred embodiments, the separators may be electrically insulating plastic films in which the particulate filler material is embedded. It is preferred that the plastic film can be penetrated by the electrolyte, for example because it has the micropores mentioned.

Preferably, the proportion of the particulate filler material in the separator is at least 40 wt. %, more preferably at least 60 wt. %, based on the mass of the separators without electrolyte.

In another preferred further development, the separators are characterized by the immediately following feature a.:

The at least one inorganic material is present as a coating on a surface of the separators.

According to this development, in preferred embodiments, the separators may be a plastic film or nonwoven or woven fabric or other electrically insulating sheet material coated with the particulate filler material.

In this case, separators are preferably used which have a base thickness in the range from 5 μm to 20 μm, preferably in the range from 7 μm to 12 μm. The total thickness of the separators results from the base thickness and the thickness of the coating.

In some embodiments, only one side of the separators is coated with the inorganic material. In other possible embodiments, the separators are coated on both sides with the inorganic material.

The thickness of the coating is preferably in the range from 0.5 μm to 5 μm. It follows from this that the total thickness of the separators in the case of a double-sided coating is preferably in the range from 6 μm to 30 μm, preferably in the range from 8 μm to 22 μm. In the case of a single-sided coating, the thickness is preferably in the range from 5.5 μm to 20.5 μm, preferably in the range from 7.5 μm to 17 μm.

Where appropriate, it may also be preferred that the separators used comprise an inorganic material as a filler and the same or a different inorganic material as a coating.

With respect to the inorganic material of the separator or separators, in preferred embodiments the separators are characterized by at least one of the immediately following features a. to e.:
a. The at least one inorganic material is or comprises an electrically insulating material.
b. The at least one inorganic material is or comprises at least one material selected from the group consisting of ceramic material, glass-ceramic material, and glass.
c. The at least one inorganic material is or comprises a lithium ion conductive ceramic material, for example Li₅AlO₄*Li₄SiO₄ or LiAlSi₂O₆.
d. The at least one inorganic material is or comprises an oxidic material, in particular a metal oxide.
e. The ceramic or oxide material is aluminum oxide (Al₂O₃), titanium oxide (TiO₂), titanium nitride (TiN), titanium aluminum nitride (TiAlN), a silicon oxide, especially silicon dioxide (SiO₂), or titanium carbonitride (TiCN).

It is preferred that the immediately preceding features a. to c. or the immediately preceding features a. and b. and d. or the immediately preceding features a. and b. and e. are realized in combination with each other.

Among the aforementioned materials, aluminum oxide (Al₂O₃), titanium oxide (TiO₂) and silicon dioxide (SiO₂) are preferred as coating materials.

In further preferred developments, the separators are characterized by at least one of the immediately following features a. to c.:
a. They comprise the at least one inorganic material only in areas.
b. They have an edge strip in which they comprise the at least one inorganic material as a coating and/or as a particulate filler material.
c. They have a main area in which they are free of the at least one inorganic material.

It is preferred that the immediately preceding features a. to c. are realized in combination with each other.

It is not necessary that the separators comprise the inorganic material in homogeneous distribution or are uniformly coated with the material everywhere. Rather, it may even be preferred that the separators are free of the inorganic material in certain regions, for example in the main region mentioned above. In this region, elevated thermal resistance of the separators is not needed as much as at their edges. In addition, the inorganic material can contribute to an unwanted elevation of the electrical resistance, especially in this region.

### Preferred Embodiments of the Current Collectors

The current collectors of the electrodes of the energy storage element have the function of electrically contacting electrochemically active components contained in the respective electrode material over as large an area as possible. Preferably, the current collectors consist of a metal or are metallized at least on the surface. In the case of electrodes for a lithium-ion system, suitable metals for the anode current collector include copper or nickel, for example, or other electrically conductive materials, in particular copper and nickel alloys or metals coated with nickel. Stainless steel is also generally a possibility. Suitable metals for the cathode current collector include aluminum or other electrically conductive materials, including aluminum alloys.

Preferably, the anode current collector and/or the cathode current collector is in each case a metal foil with a thickness in the range from 4 μm to 30 μm, in particular a ribbon-shaped metal foil with a thickness in the range from 4 μm to 30 μm.

In addition to foils, however, other substrates such as metallic or metallized nonwovens or open-pore metallic foams or expanded metals can be used as current collectors.

The current collectors are preferably loaded on both sides with the respective electrode material.

In some preferred embodiments, the energy storage element may be characterized by at least one of the immediately following features a. to c.:
a. The main areas of the current collectors connected to the contact element by welding or soldering have a plurality of apertures.
b. The apertures in the main area are round or square holes, especially punched or drilled holes.
c. The current collectors connected to the contact element by welding are perforated in the main area, in particular by round hole or slotted hole perforation.

Preferably, the immediately preceding features a. and b. or a. and c., and especially preferably the three immediately preceding features a. to c., are realized in combination with each other.

The plurality of apertures results in a reduced volume and also in a reduced weight of the current collectors. This makes it possible to incorporate more active material into the electrodes and thus drastically increase the energy density of an electrochemical cell formed from them. Energy density increases in the double-digit percentage range can be achieved in this way.

In some preferred embodiments, the apertures are introduced into the main region by laser.

In principle, the geometry of the apertures is not essential. What is important is that as a result of the insertion of the apertures, the mass of the current collectors is reduced and there is more space for active material, since the apertures can be filled with the active material.

It can be very advantageous to ensure that the maximum diameter of the apertures is not too large when inserting them. Preferably, the dimensions of the apertures should not be more than twice the thickness of the layer of electrode material on the respective current collector.

In preferred embodiments, the energy storage element is characterized by the immediately following feature a:
a. The apertures in the current collectors, especially in the main regions, have diameters in the range from 1 μm to 3000 μm.

Within this preferred region, diameters in the range from 10 μm to 2000 μm, preferably from 10 μm to 1000 μm, in particular from 50 μm to 250 μm, are further preferred.

Preferably, the energy storage element further has at least one of the immediately following features a. and b.:
a. The current collectors connected to the contact element by welding or soldering have a lower weight per unit area than the free edge strip of the same current collectors, at least in a partial section of the respective main area.
b. The current collectors connected to the contact element by welding or soldering have no or fewer apertures per unit area in the free edge strips than in the main area.

It is preferred that the immediately preceding features a. and b. are realized in combination with each other.

The free edge strips of the anode and cathode current collectors delimit the main area towards the edge along which they extend. In the case of a current collector provided with the apertures, the apertures also characterize the main area. In other words, the boundary between the main region and the free edge strip or strips may, in preferred embodiments, correspond to a transition between regions with and without apertures.

The apertures are preferably distributed substantially evenly over the main area.

In further preferred embodiments, the energy storage element has at least one of the immediately following features a. to c.:
a. The weight per unit area of the current collectors in the main area is reduced by 5% to 80% compared to the weight per unit area of the current collectors in the free edge strips.
b. The current collectors have a hole area in the main region in the range from 5% to 80%.
c. The current collector has a tensile strength of 20 N/mm 2 to 250 N/mm² in the main area.

It is preferred that the immediately preceding features a. to c. are realized in combination with each other.

The hole area, often referred to as the free cross-section, can be determined according to ISO 7806-1983. The tensile strength of the current collector in the main area is reduced compared to current collectors without the apertures. Its determination can be done according to DIN EN ISO 527 part 3.

Preferably, the energy storage element has the immediately following feature a.:
a. The main areas of the anode current collectors and the main areas of the cathode current collectors are both characterized by a plurality of the apertures.

The preferred embodiments of the current collector provided with the apertures described above are independently applicable to the anode current collectors and the cathode current collectors.

The use of perforated current collectors or those otherwise provided with a plurality of apertures has not yet been seriously considered for lithium-ion cells, since it is very difficult to contact such current collectors electrically. As mentioned at the outset, the electrical connection of the current collectors is conventionally made via separate electrical current conductors. However, reliable welding of these current conductors to perforated current collectors in industrial mass production processes is difficult to realize for conventional lithium-ion cells without an acceptable failure rate.

According to the disclosure, this problem is solved by welding or soldering the free edge strips of the anode current collectors and/or the cathode current collectors to the contact element(s) as described. The concept according to the disclosure makes it possible to completely dispense with separate current conductors, thus enabling the use of current collectors with a low material content and provided with apertures. It is particularly advantageous if the free edge strips of the current collectors are not provided with apertures, since in these cases in particular welding can be performed especially reliably with exceptionally low reject rates. This applies in particular if the edges of the current collectors are provided with the support layer or support material described below and, if necessary, the separator is improved against thermal loads as described above.

### Support Coating

In the free edge strips, the metal of the respective current collector is preferably free of the respective electrode material. In some preferred embodiments, the metal of the respective current collector is uncovered there so that it is available for electrical contacting, for example for welding or soldering to the contact element.

However, in some further embodiments, the metal of the respective current collector in the free edge strips may also be coated, at least in some areas, with a support material that is different from the electrode material disposed on the respective current collector.

This support material stabilizes the edge strip and is intended to prevent unintentional bending or melting down of the edge strip, especially when making the welded or soldered connection to the contact element.

The support material that can be used preferably has at least one of the immediately following additional features a. to e.:
a. The support material is a non-metallic material.
b. The support material is an electrically insulating material.
c. The non-metallic material is a ceramic material, a glass-ceramic material or a glass.
d. The ceramic material is aluminum oxide (Al₂O₃), titanium oxide (TiO₂), titanium nitride (TiN), titanium aluminum nitride (TiAlN), a silicon oxide, especially silicon dioxide (SiO₂), or titanium carbonitride (TiCN).
e. The support material is a metal that has a higher melting point than the metal of the respective current collector.

The support material is preferably formed according to the immediately preceding feature b. and especially preferably according to the immediately preceding feature d.

The term non-metallic material comprises in particular plastics, glasses and ceramic materials.

The term “electrically insulating material” is to be understood broadly in this context. In principle, it comprises any electrically insulating material, in particular also said plastics.

The term ceramic material is to be understood broadly in this context. In particular, this includes carbides, nitrides, oxides, silicides or mixtures and derivatives of these compounds.

By the term “glass-ceramic material” is meant in particular a material comprising crystalline particles embedded in an amorphous glass phase.

The term “glass” basically means any inorganic glass that satisfies the thermal stability criteria defined above and that is chemically stable to any electrolyte that may be present in the cell.

Preferably, the anode current collector consists of copper or a copper alloy while at the same time the cathode current collector consists of aluminum or an aluminum alloy and the support material is aluminum oxide or titanium oxide.

In preferred embodiments, the energy storage element has at least one of the immediately following features a. to c:
a. The free edge strip of the anode current collector and/or the free edge strip of the cathode current collector comprise a first sub-region and a second sub-region, wherein the first sub-region is coated with the support material while the second sub-region is uncoated.
b. The first sub-region and the second sub-region each have the shape of a line or a strip and run parallel to each other.
c. The first sub-region is located between the main region of the anode current collector or the cathode current collector and the second sub-region.

It is preferred that the immediately preceding features a. to c. are realized in combination with each other.

In an alternative embodiment, it may be preferred that the energy storage element is characterized by the immediately following feature a.:

a. The free edge strip of the anode current collector and/or the free edge strip of the cathode current collector is fully coated with the support material.

The coating of the anode current collector with the support material can be carried out according to different methods, for example by dry coating or deposition from a dispersion or from the gas phase, optionally using a compatible binder system.

### Preferred Embodiments of the Electrochemical System

In a first, preferred variant of the electrochemical system, the energy storage element has the immediately following feature a.:
a. The negative electrode material comprises as active material at least one material selected from the group consisting of silicon, aluminum, tin, antimony, and a compound or alloy of these materials capable of reversibly intercalating and deintercalating lithium, in an amount of from 20 wt % to 90 wt %.

The weights given here refer to the dry mass of the negative electrode material, i.e. without electrolyte and without taking into account the weight of the anode current collector.

Tin, aluminum, antimony and silicon can form intermetallic phases with lithium. The capacity to absorb lithium exceeds that of graphite or comparable materials many times over, especially in the case of silicon.

Among the active materials mentioned, which can preferably also be used in the form of particles, silicon is preferred. According the disclosure, negative electrodes are preferred which contain silicon as active material in a proportion of 20 wt. % to 90 wt. %.

Also, some compounds of silicon, aluminum, tin, and/or antimony can reversibly deposit and remove lithium. For example, in some preferred embodiments, the silicon may be present in oxidic form in the negative electrode. In these embodiments, it may be preferred that the negative electrode comprise silicon oxide in an amount ranging from 20 wt % to 90 wt %.

The design of the energy storage element enables a significant advantage. As mentioned at the outset, in cases where the electrical connection of cells is made via separate current conductors, greater thermomechanical stresses can act on the electrodes during charging and discharging immediately in the vicinity of the current conductors than away from the current conductors. This difference is particularly pronounced for negative electrodes containing silicon, aluminum, tin and/or antimony as active material. The electrical connection of the current collectors via contact elements, on the other hand, not only enables comparatively uniform and efficient heat dissipation from the electrodes, but it also distributes the thermomechanical stresses occurring during charging and discharging evenly over the electrodes. Surprisingly, this makes it possible to control very high proportions of silicon and/or tin and/or antimony in the negative electrode. Even at high proportions, comparatively little or no damage occurs during charging and discharging as a result of the thermomechanical stresses. By elevating the proportion of silicon, for example, in the anode, the energy density of the energy storage element can be greatly increased.

The skilled person understands that the tin, aluminum, silicon and antimony do not necessarily have to be metals in their purest form. For example, silicon particles may also contain traces or proportions of other elements, in particular other metals (apart from the lithium contained in any case as a function of the state of charge), for example in proportions of up to 40% by weight, in particular in proportions of up to 10% by weight. Thus, alloys of tin, aluminum, silicon and antimony can also be used.

In preferred embodiments of the first, preferred variant, the energy storage element has at least one of the immediately following features a. and b:
a. The negative electrode material further comprises, as the negative active material, carbon-based particles capable of reversible lithium insertion and removal, such as graphitic carbon, in particular a mixture of the silicon and these carbon-based particles.
b. The carbon-based particles capable of intercalating lithium are present in the electrode material in a proportion of from 5% to 75% by weight, in particular in a proportion of from 15% to 45% by weight.

For example, carbon-based particles such as graphitic carbon or non-graphitic carbon materials capable of intercalating lithium, preferably also in particle form, can be used as active materials in the negative electrode. Alternatively or additionally, lithium titanate (Li₄Ti₅O₁₂) or a derivative thereof may also be included in the negative electrode, preferably also in particle form.

In further preferred embodiments of the first preferred variant, the energy storage element has at least one of the immediately following features a. to c.:
a. The negative electrode material comprises an electrode binder and/or a conductive agent to elevate the electrical conductivity of the negative electrodes.
b. The electrode binder is contained in the negative electrode material in a proportion of 1 wt. % to 15 wt. %, in particular in a proportion of 1 wt. % to 5 wt. %.
c. The conductive agent is present in the negative electrode material in a proportion of 0.1 wt. % to 15 wt. %, in particular in a proportion of 1 wt. % to 5 wt. %.

It is preferred that the immediately preceding features a. to c. are realized in combination with each other.

Again, the active materials are preferably embedded in a matrix of the electrode binder, with adjacent particles in the matrix preferably in contact with each other.

Suitable electrode binders are also based here, for example, on polyvinylidene fluoride (PVDF), polyacrylate, styrene-butadiene rubber (SBR) or carboxymethyl cellulose. Suitable conductive agents include carbon black, graphite, graphene, carbon nanofibers and metal powder.

In the context of the first, preferred variant, it is especially preferred that the positive electrode material comprises a PVDF binder and the negative electrode material comprises a polyacrylate binder, in particular lithium polyacrylic acid.

In the first, preferred variant, lithium metal oxide compounds and lithium metal phosphate compounds such as LiCoO₂ and LiFePO₄ are suitable active materials for the positive electrodes. Furthermore, lithium nickel manganese cobalt oxide (NMC) with the chemical formula LiNiₓMn_{y}Co_{z}O₂ (where x+y+z is typically 1) is particularly well suited, lithium manganese spinel (LMO) with the chemical formula LiMn₂O₄ or lithium nickel cobalt alumina (NCA) with the chemical formula LiNiₓCo_{y}Al_{z}O₂ (where x+y+z is typically 1). Derivatives thereof, for example lithium nickel manganese cobalt alumina (NMCA) with the chemical formula Li_{1.11}(Ni_{0.40}Mn_{0.39}Co_{0.16}Al_{0.05})_{0.89}O₂ or Li₁₊ₓM-O compounds and/or mixtures of said materials can also be used.

The high silicon content in the anodes of an energy storage element requires correspondingly high-capacity cathodes in order to be able to achieve a good cell balance. Therefore, NMC, NCA or NMCA are preferred.

In preferred embodiments of the first, preferred embodiment, the positive electrodes are characterized by at least one of the immediately following features a. to e.:
a. The positive electrode material comprises as active material at least one metal oxide compound capable of reversible lithium incorporation and removal, preferably one of the above compounds, in particular NMC, NCA or NMCA.
b. The at least one oxidic compound is present in the electrode material in a proportion of from 50% by weight to 99% by weight, in particular in a proportion of from 80% by weight to 99% by weight.
c. The positive electrode material also preferably comprises the electrode binder and/or the conductive agent.
d. The electrode binder is present in the positive electrode material in a proportion of 0.5 wt. % to 15 wt. %, preferably in a proportion of 1 wt. % to 10 wt. %, especially in a proportion of 1 wt. % to 2 wt. %.
e. The conductive agent is contained in the positive electrode material in an amount of 0.1 wt % to 15 wt %.

It is preferred that the immediately preceding features a. to e. are realized in combination with each other.

In the case of both positive and negative electrodes, it is preferred that the percentages of each component contained in the electrode material add up to 100% by weight.

While high-capacity cathodes can store lithium reversibly in the range from 200-250 mAh/g, the theoretical capacity of silicon is approx. 3500 mAh/g. This leads to comparatively thick cathodes with high surface charge and very thin anodes with low surface charge. Since materials such as silicon react strongly to small voltage changes due to their very high capacitance, the anode current collector should be coated as homogeneously as possible. Even small differences in the loading of the current collector and/or the densification of the electrode material can lead to strong local deviations in the electrode balance and/or stability.

For this reason, in preferred embodiments of the first, preferred variant, the negative electrodes are characterized by the immediately following feature a.:
a. The weight per unit area of the negative electrodes deviates from a mean value by a maximum of 2% per unit area of at least 10 cm².

The mean value is the quotient of the sum of at least 10 measurement results divided by the number of measurements performed.

Furthermore, the energy storage element preferably comprises an electrolyte, for example based on at least one lithium salt such as lithium hexafluorophosphate (LiPF₆), which is dissolved in an organic solvent (e.g. in a mixture of organic carbonates or a cyclic ether such as THF or a nitrile). Other lithium salts that can be used include lithium tetrafluoroborate (LiBF₄), lithium bis(trifluoromethanesulfonyl)imide (LiTFSI), lithium bis(fluorosulfonyl)imide (LiFSI), and lithium bis(oxalato)borate (LiBOB).

In preferred embodiments of the first, preferred variant, the energy storage element has at least one of the immediately following features a. to d.:
a. It comprises an electrolyte comprising a mixture of tetrahydrofuran (THF) and 2-methyltetrahydrofuran (mTHF).
b. The volume ratio of THF:to mTHF in the mixture is in the range from 2:1 to 1:2, most preferably it is 1:1.
c. It comprises an electrolyte comprising LiPF₆ as a conducting salt.
d. The conducting salt in a proportion of 1 to 2.5 M, in particular in a proportion of 1 to 1.5 M, is contained in the electrolyte.

In the first, preferred variant, the electrolyte is characterized by all the above features a. to d.

In alternative, preferred embodiments, the energy storage element in the first, preferred variant is characterized by at least one of the immediately following features a. to e:
a. It comprises an electrolyte comprising a mixture of fluoroethylene carbonate (FEC) and ethyl methyl carbonate (EMC).
b. The volume ratio of FEC:to EMC in the mixture is in the range from 1:7 to 5:7, preferably it is 3:7.
c. It comprises an electrolyte comprising LiPF₆ as a conducting salt.
d. The conducting salt is present in the electrolyte at a concentration of 1.0 to 2.0 M, in particular 1.5 M.
e. The electrolyte comprises vinylene carbonate (VC), in particular in a proportion of 1 to 3% by weight.

Preferably, the electrolyte is characterized by all of the above features a. to e.

To improve cycling stability, the ratio of anode to cathode capacitances is preferably balanced so that the potential capacitance of the silicon is not fully utilized.

In the first, particularly preferred variant, the energy storage element has the following features immediately below:

a. The capacitances of anodes to cathodes of the energy storage element are balanced such that only 700-1500 mAh is reversibly used in operation per gram of electrode material of the negative electrode.

This measure allows volume changes to be reduced.

### Other Preferred Embodiments of the Electrochemical System

In a second, preferred variant of the electrochemical system, the energy storage element is particularly characterized by the immediately following additional feature a.:
a. The negative electrode material layer comprises metallic lithium.

While high-capacity cathodes can store lithium reversibly in the range from 200-250 mAh/g, the theoretical capacity of metallic lithium is about 3842 mAh/g. This allows the production of cells with very thin anodes. On the cathode side, however, a comparatively high surface charge is required. Overall, however, the energy density can be increased considerably.

The anode may be present as a thin layer of metallic lithium in some preferred embodiments of the second, preferred variant of the electrochemical system. This layer can be deposited, for example, by means of a CVD or PVD method (CVD=chemical vapor deposition, PVD=physical vapor deposition) from the gas phase on the anode current collector.

However, the energy storage element in the second, preferred variant has at least one of the immediately following two additional features a. and b:
a. The layer of negative electrode material comprises a porous, electrically conductive matrix with an open-pore structure.
b. Metallic lithium is embedded in the pores of the matrix.

Preferably, the immediately preceding additional features a. and b. are realized in combination.

If necessary, the anode can comprise at least one further material in addition to the metallic lithium, for example at least one metal with which the lithium is alloyed. If necessary, the at least one further material is likewise embedded in the pores of the matrix.

One problem that has so far prevented the marketability of cells with metallic lithium anodes is that such anodes are completely degraded during a complete discharge. The volume of the anodes can therefore approach zero during discharge. As in the case of silicon as the active material, this can result in massive volume changes within the cells, which are repeated in the opposite direction during charging. The problem is particularly critical if, as in the case of the energy storage element, layered anodes and cathodes are stacked in alternating sequence. In this case, the respective volume changes add up.

Another problem that can occur with cells with metallic lithium anodes is that the metallic lithium builds up unevenly on the anode side during charging, and in extreme cases dendrites can even form.

The electrically conductive matrix with the open-pore structure ensures that volume changes occurring on the anode side during charging and discharging processes are minimized. Starting from a charged state in which the lithium is at least predominantly, and if necessary also completely, in the pores of the matrix, the lithium is depleted in the anode during discharging. Unlike prior art cells with a metallic lithium anode, however, the anode loses virtually no volume, as this is largely determined by the matrix. During charging, the lithium can be deposited uniformly in the anode again due to the electrical conductivity of the matrix. Uneven lithium deposition and the associated local volume increases or even dendrite formation can thus be avoided. In addition, in combination with the connection of the free edge strips of the anode current collectors and/or the cathode current collectors to the contact element, voltage and temperature gradients are minimized.

The open-pored structure of the matrix is of great importance. As is generally known, an open-pored structure is a structure that has a plurality of pores that are connected to each other by channels or apertures in the pore walls. As a result, open-pored structures generally have a large internal surface area.

In a preferred further development, the matrix in the second, preferred variant of the electrochemical system has at least one of the immediately following two additional features a. and b:
a. The matrix has a porosity in the range from 40 to 95%.
b. The pores in the matrix are characterized by an average diameter in the range from 2 to 50 μm.

Preferably, the immediately preceding additional features a. and b. are realized in combination.

The determination of porosities (ratio of volume of the pores/total volume of the matrix) and pore size distributions is no longer a problem today. There are numerous measuring instruments that perform corresponding determinations according to standardized methods. The above values refer to determinations according to the ISO 15901-1 and DIN 66133 standards.

In possible further developments of the immediately preceding feature a., the matrix preferably has a porosity in the range from 50% to 95%, preferably from 70% to 95%, especially from 80% to 95%.

In possible further developments of the immediately preceding feature b., the pores in the matrix preferably have an average diameter in the range from 7.5 to 150 μm, preferably from 9 to 130 μm, especially from 10 to 120 μm.

The pores in the matrix are preferably connected by passages having an average diameter in the range from 0.5 μm and 50 μm, more preferably in the range from 1 to 40 μm, in particular in the range from 1 to 25 μm, most preferably from 1 to 10 μm.

Ideally, the matrix consists of a material that does not change chemically during charging and discharging of the cell.

In a preferred further development, the matrix in the second, preferred variant of the electrochemical system is characterized by at least one of the four immediately following additional features a. to d:
a. The matrix comprises carbon formed by carbonization of an organic compound.
b. The matrix comprises the carbon in a proportion in the range from 50 to 100% by weight.
c. In addition to the carbon, the matrix contains at least one filler which has a higher or lower electrical conductivity than the carbon.
d. The filler is at least one member selected from the group consisting of carbon black, CNT, graphene and metal particles.

Preferably, the immediately preceding additional features a. and b., preferably the immediately preceding additional features a. to d., are realized in combination.

Suitable variants of carbonizable organic compounds and also of methods for carbonization are described in EP 2669260 A1, WO 2017/086609 A1 and U.S. Pat. No. 5,510,212 A, the contents of which are hereby made by reference in their entirety the contents of the present description.

Very preferably, the porous, electrically conductive matrix with an open-pore structure is manufactured from a porous organic compound, in particular a polymer with a porous structure.

The formation of this porous organic compound, in particular of the polymer with the porous structure, can be carried out according to EP 2669260 A1, for example, by polymerizing the monomer phase of a monomer-water emulsion, for example by ring-opening metathesis polymerization (ROMP) of a diene compound accessible for this purpose. During polymerization, water droplets are entrapped. After subsequent removal of the water, voids remain in their place. The resulting polymer matrix with these cavities can be carbonized in a subsequent step, whereby intermediate steps such as oxidative treatment may still be necessary.

Incidentally, carbonization in this context means a conversion of an organic compound to almost pure carbon. Such a conversion generally takes place at very high temperatures and in the absence of oxygen. For example, a polymer can be heated for carbonization to a temperature in the range from 550° C. to 2500° C., preferably in an oxygen-free atmosphere.

The properties of the matrix, in particular its pore size, can also be specifically adjusted according to EP 2669260 A1. For this purpose, different amounts of a surfactant can be added to the monomer-in-water emulsion. Preferably, the volume fraction of the surfactant is varied in the range from 0.1% to 8% (based on the amount of polymerizable monomer in the emulsion).

The filler according to feature c. can be used to selectively increase or decrease the electrical conductivity of the matrix. To introduce the filler, it can be added, for example, to the monomer-in-water emulsion mentioned above.

Preferably, the matrix comprises the at least one filler in a proportion in the range from 0.1 to 30% by weight.

In a preferred further development, the energy storage element in the second, preferred variant is characterized by the immediately following additional feature a.:

The layer of negative electrode material on the anode current collector has a thickness in the range from 5 to 100 μm.

The metallic lithium can be introduced into the pores of the matrix by means of electrochemical deposition, for example. For this purpose, the matrix can be contacted with a lithium salt solution and connected to the negative pole of a DC voltage source. Alternatively, a cathode material containing lithium ions, for example an NMC material or LiMoO₃ or Li₃N, can be used on the cathode side. The electrochemical deposition of the metallic lithium in the pores of the matrix then takes place during the first charging. Another possibility would be to deposit the lithium by CVD or PVD.

For the positive electrodes, for example, lithium metal oxide compounds and lithium metal phosphate compounds such as LiCoO₂ and LiFePO₄ are suitable as active materials in the second, preferred variant of the electrochemical system. In particular, derivatives of LiFePO₄ in which Fe is partially replaced by Co, Ni or Mn are also of interest. Further well suited are in particular lithium nickel manganese cobalt oxide (NMC) with the chemical formula LiNiₓMn_{y}Co_{z}O₂ (where x+y+z is typically 1), Lithium manganese spinel (LMO) with the chemical formula LiMn₂O₄, or lithium nickel cobalt alumina (NCA) with the chemical formula LiNiₓCo_{y}Al_{z}O₂ (where x+y+z is typically 1). Derivatives thereof, for example lithium nickel manganese cobalt alumina (NMCA) with the chemical formula Li_{1.11}(Ni_{0.40}Mn_{0.39}Co_{0.16}Al_{0.05})_{0.89}O₂ or Li₁₊ₓM-O compounds and/or mixtures of the above materials can also be used. The cathodic active materials mentioned are preferably used in particulate form.

In a preferred embodiment of the second, preferred variant, the cathode of the energy storage element correspondingly has at least one of the immediately following additional features a. toe.:
a. The positive electrode material comprises as active material at least one metal oxide compound capable of reversible lithium insertion and removal, preferably an oxide cobalt and/or manganese compound, preferably NMC, NCA or NMCA.
b. The at least one metal oxide compound capable of reversible lithium incorporation and removal is contained in the electrode material in an amount of from 80 wt % to 99 wt %.
c. The positive electrode material comprises an electrode binder and/or a conductive agent to elevate the electrical conductivity of the positive electrodes.
d. The electrode binder is present in the positive electrode material in an amount of from 0.5% to 15% by weight, preferably from 0.5% to 5% by weight.
e. The conductive agent is present in the positive electrode material in an amount of from 0.1% to 15% by weight, preferably from 0.5% to 3.5% by weight.

Preferably, the immediately preceding additional features a. to e. are realized in combination.

Here, too, the active materials of the cathode are preferably embedded in a matrix of the electrode binder, with adjacent particles in the matrix preferably being in direct contact with one another. Suitable electrode binders are based, for example, on polyvinylidene fluoride (PVDF), polyacrylate, styrene-butadiene rubber (SBR) or carboxymethyl cellulose. Suitable conductive agents include carbon black, graphite, graphene, carbon nanofibers and metal powder.

In another preferred embodiment of the second preferred variant, the energy storage element has at least one of the immediately following additional features a. and b:
a. The layer of positive electrode material comprises a porous, electrically conductive matrix with an open-pore structure.
b. Sulfur is incorporated into this matrix.

Preferably, the immediately preceding additional features a. and b. are realized in combination.

Thus, in preferred embodiments of the second, preferred variant, the cathodes are cathodes containing sulfur as active material. The energy storage element may thus comprise lithium-sulfur cells. For example, the cathodes may comprise a mixture of sulfur with an additive to improve electrical conductivity, for example from the group comprising graphite, carbon black, CNT and graphene. Alternatively, the cathodes may comprise the sulfur in a chemically modified form, for example as polysulfide.

In the second, preferred variant, the energy storage element preferably comprises separators made of at least one electrically insulating plastic film that can be penetrated by a liquid electrolyte, in particular a plastic film with appropriately dimensioned pores. The foil can consist of a polyolefin or a polyetherketone, for example. Nonwovens and fabrics made of plastic materials or other electrically insulating sheet structures can also be used as separators within the scope of the second, preferred variant. Preferably, separators are used which have a thickness in the range from 5 μm to 50 μm.

As an alternative to a separator-liquid electrolyte combination, the cell can also have a solid state electrolyte instead of the separator according to the second, preferred variant, for example a solid state electrolyte as already specified above.

If the cathodes are those with sulfur as active material, the separator can have a protective layer that protects the anode from the electrolyte and any lithium sulfides dissolved in it. This protective layer can be applied to the cathode side of the separator, for example.

In the second, preferred variant, it is preferred that the energy storage element comprises, in addition to the separator consisting of the at least one electrically insulating plastic film, a liquid electrolyte which consists of a solvent or solvent mixture and a lithium ion-containing conducting salt and with which the separator is impregnated. Suitable conducting salts include LiTFSI or LiPF₆ or LiBF₄. Suitable solvents include organic carbonates, in particular ethylene carbonate (EC), propylene carbonate (PC), 1,2-dimethoxyethane (DME), ethyl methyl carbonate (EMC), dimethyl carbonate (DMC) or diethyl carbonate (DEC) and mixtures thereof.

If the cathodes are those with sulfur as the active material, for example, a mixture of dioxolane (DOL) and of DME can be used as the solvent. In addition, the electrolyte may contain a passivation additive such as lithium nitrate (LiNO₃).

In a first, preferred further development of the second, preferred variant, the energy storage element has, with regard to the electrolyte, at least one of the four immediately following additional features a. to d:
a. The electrolyte comprises a mixture of tetrahydrofuran (THF) and 2-methyltetrahydrofuran (mTHF).
b. The volume ratio of THF:to mTHF in the mixture is in the range from 2:1 to 1:2, most preferably it is 1:1.
c. The electrolyte comprises lithium hexafluorophosphate (LiPF₆) as the conducting salt.
d. The conducting salt is present in the electrolyte in a proportion of 1.5 to 2.5 M, in particular 2 M.

Preferably, the four immediately preceding features a. to d. are realized in combination with each other.

In a second, preferred further development of the second, preferred variant, the energy storage element has, with respect to the electrolyte, at least one of the six immediately following additional features a. to f:
a. The electrolyte comprises a mixture of ethylene carbonate (EC) and dimethyl carbonate (DMC).
b. The volume ratio of EC:to DMC in the mixture is in the range from 1:7 to 5:7, preferably it is 3:7.
c. The electrolyte comprises LiPF₆ as the conducting salt.
d. The conducting salt is present in the electrolyte at a concentration of 1.0 to 2.0 M, in particular 1.2 to 1.5 M.
e. The electrolyte comprises vinylene carbonate, in particular in a proportion of 1 to 3% by weight.
f. The electrolyte comprises ethylene sulfate (DTD), in particular in a proportion of 0.5 to 2% by weight.

Preferably, the six immediately preceding features a. to f. are realized in combination with each other.

In a third, preferred development of the second, preferred variant, the energy storage element has, with respect to the electrolyte, at least one of the six immediately following additional features a. to f:
a. The electrolyte comprises a mixture of ethylene carbonate (EC), dimethyl carbonate (DMC), and methyl acetate (MA).
b. The volume fraction of EC and MA in the mixture is each in the range from 20% to 40% by volume and the volume fraction of DMC in the mixture is in the range from 30% to 50% by volume.
c. The electrolyte comprises LiPF₆ as the conducting salt.
d. The conducting salt is present in the electrolyte at a concentration of 1.0 to 2.0 M, in particular 1.2 to 1.5 M.
e. The electrolyte comprises vinylene carbonate, in particular in a proportion of 1 to 3% by weight.
f. The electrolyte comprises ethylene sulfate (DTD), in particular in a proportion of to 2% by weight.

Preferably, the six immediately preceding features a. to f. are realized in combination with each other.

In a fourth, preferred further development of the second, preferred variant, the energy storage element has, with respect to the electrolyte, at least one of the four immediately following additional features a. to d:
a. The electrolyte comprises a mixture of 1,3-dioxolane (DOL) and dimethoxyethane (DME).
b. The volume ratio of DOL:to DME in the mixture is in the range from 2:1 to 1:2, preferably it is 1:1.
c. The electrolyte comprises lithium bis(trifluoromethane) sulfonyl imide (LiTFSI) as the conducting salt.
d. The conducting salt is present in the electrolyte in a concentration of 0.5 to 2.0 M, in particular 1 M.

Preferably, the four immediately preceding features a. to d. are realized in combination with each other.

In a fifth, preferred further development of the second, preferred variant, the energy storage element has, with respect to the electrolyte, at least one of the four immediately following additional features a. to d:
a. The electrolyte comprises at least one solvent selected from the group consisting of acetonitrile (AN), propylene carbonate (PC), tetrahydrofuran (THF), dimethyl carbonate (DMC), diethyl carbonate (DEC), ethyl methyl carbonate (EMC), ethylene carbonate (EC), vinyl carbonate (VC), and fluoroethylene carbonate (FEC).
b. Dissolved in the electrolyte is at least one compound selected from the group consisting of fluoromethane (FM), difluoromethane (DFM), fluoroethane (FE), 1,1-difluoroethane (1,1-DFE), 1,1,1,2-tetrafluoroethane (1,1,1,2-TFE), and 2-fluoropropane (2-FP).
c. The electrolyte comprises lithium bis(trifluoromethane) sulfonyl imide (LiTFSI) as the conducting salt.
d. The conducting salt is present in the electrolyte at a concentration of 0.5 to 2.0 M, in particular 1.2 M.

Preferably, the four immediately preceding features a. to d. are realized in combination with each other.

In a sixth, preferred further development of the second, preferred variant, the energy storage element has, with respect to the electrolyte, at least one of the immediately following three additional features a. to c:
a. The electrolyte comprises at least one solvent selected from the group consisting of propylene carbonate (PC), dimethoxyethane (DME), acetonitrile (AN), dimethyl sulfoxide (DMSO), tetrahydrofuran (THF), sulfolane (SL), and ethyl acetate (EA).
b. The electrolyte comprises a conducting salt in an amount of 2.5 to 6.0 mol.
c. The conducting salt is LiTFSI.

Preferably, the three immediately preceding features a. to c. are realized in combination with each other.

### Preferred Structural Properties of the Electrodes and the Assembly.

The assembly of the energy storage element is preferably formed of 2 to 1000 stacked electrodes, preferably of 10 to 500 stacked electrodes, especially of 20 to 500 stacked electrodes.

Within the assembly, the electrodes can form cells with the sequence “anode/separator/cathode” or “anode/solid state electrolyte/cathode”, with the separator or the solid state electrolyte spatially separating the oppositely poled electrodes.

Within the assembly, electrodes with the same polarity are preferably identical, especially with regard to their capacitance.

Preferably, the energy storage element has at least one of the immediately following features a. and b.:
a. The electrodes are polygonal in shape, preferably they have a rectangular circumference.
b. The assembly has a prismatic shape.

Preferably, the two immediately preceding features a. and b. are realized in combination with each other.

Preferably, the electrodes are rectangular, for example square. A hexagonal shape is also preferred in some embodiments. Correspondingly, the assembly of the stacked rectangular electrodes preferably has a cuboid, in particular a cubic, geometry.

Accordingly, the assembly generally comprises at least six sides. The sides from which the free edge strips of the anode current collectors and the free edge strips of the cathode current collectors protrude may be opposite sides of the assembly or adjacent sides of the assembly.

Preferably, the electrodes have a thickness in the range from 1 μm to 200 μm. In some embodiments, the anodes are much thinner than the cathodes, in particular if they are based on metallic lithium or if they comprise portions of metallic silicon.

If the electrodes are polygonal, they preferably have side lengths in the range from cm to 200 cm. In the case of rectangular electrodes, side lengths in the range from 0.5 cm to 200 cm are also preferred.

Preferably, the electrodes and the separator or the solid electrolyte are formed as flat, planar layers.

Preferably, each of the stacked electrodes within the assembly comprises two flat sides separated from each other by a plurality of edges, for example, in the case of an electrode of rectangular shape, by two longitudinal edges and two transverse edges. Apart from the terminal electrodes of the assembly, in which only one of the flat sides can come into indirect contact with an adjacent electrode, the flat sides of the electrodes are each in contact with an adjacent electrode within the assembly via a separator or a layer of the solid electrolyte, wherein adjacent electrodes are differing in polarity. The flat sides in contact via the separator or the solid electrolyte layer overlap in an overlap region, which is defined by the fact that within the overlap region a straight line perpendicular to one of the flat sides also intersects the other flat side.

With identical size and non-staggered arrangement of the stacked electrodes within the assembly, the size of the overlay area corresponds exactly to the area of the flat sides. Preferably, the size of the overlay area is >90%, preferably >95%, of the area of the flat sides.

The separators comprised by the assembly are preferably somewhat larger in size than the electrodes separated by them. Preferably, the sides of the composite body are formed by the edges of the respective separator, including the sides from which the free edge strips of the anode current collectors and the free edge strips of the cathode current collectors protrude. The same applies if the assembly comprises the layers of the solid state electrolyte instead of separators.

To ensure that the free edge strips of the anode current collectors of the stacked electrodes protrude from one side of the assembly and the free edge strips of the cathode current collectors protrude from another side of the assembly, the anodes and the cathodes can be formed and/or arranged relative to each other within the assembly in a suitable manner. For example, for this purpose
the edge strips must have an appropriate width and/or
the anodes and the cathodes and, if necessary, also the separators can be arranged offset to each other within the assembly.

Within the assembly, the electrodes are preferably arranged such that the free edge strips of the cathode current collectors all protrude from one of the sides of the assembly and the free edge strips of the anode current collectors all protrude from another of the sides of the assembly. For this purpose, electrodes can also be arranged offset to each other within the stack.

It is preferred that the edges of the anode current collector and/or the cathode current collector protruding from the sides of the assembly do not exceed 5000 μm, preferably not exceed 3500 μm.

Preferably, the edge of the anode current collector protrudes from one of the sides of the assembly no more than 2500 μm, especially preferably no more than 1500 μm. Preferably, the edge of the cathode current collector protrudes from another side of the assembly no more than 3500 μm, especially preferably no more than 2500 μm.

The figures for the projection of the anode current collector and/or the cathode current collector refer to the free projection before the sides are brought into contact with the contact element(s). When welding or soldering the contact element, deformation of the edges of the current collectors may occur.

The smaller the free projection is selected, the larger the main areas of the current collectors covered with electrode material can be formed. This can contribute positively to the energy density of the energy storage element.

A particular advantage of the energy storage element is that it can be provided with a particularly high specific energy density as well as with particularly good heat dissipation properties, as will be explained in more detail below.

### Preferred Properties of the Contact Element(s)

The concept of welding the edges of current collectors with contact elements is already known from WO 2017/215900 A1 or JP 2004-119330 A, although it is described there only in connection with cylindrical round cells. The use of contact elements enables particularly high current carrying capacities and low internal resistance. With regard to suitable methods for electrically connecting contact elements to the edges of current collectors, full reference is therefore made to the contents of WO 2017/215900 A1 and JP 2004-119330 A.

Preferably, the energy storage element comprises two contact elements, one of which is in direct contact with the free edge of the anode current collector and the other of which is in direct contact with the free edge of the cathode current collector, the contact elements and the edges in contact therewith each being connected by welding or soldering.

In the manufacture of conventional electrode stacks consisting of several cells, care is taken to prevent arresters connected to current collectors with opposite polarity from protruding from one another in order to avoid the risk of a short circuit. Since, the free edge strips of the anode current collectors protrude from one side of the assembly and the free edge strips of the cathode current collectors protrude from another side of the assembly, there is no risk of a short circuit as a result of direct contact of oppositely poled current collectors in the energy storage element.

The contact elements serve as a central conductor for the currents drawn from the electrodes during operation of the energy storage element. Here, the free edge strips of the anode current collectors and the cathode current collectors can ideally be connected to the contact elements over their entire length. Such electrical contacting significantly reduces the internal resistance within the energy storage element. The arrangement described can thus absorb the occurrence of large currents very well. With minimized internal resistance, thermal losses at high currents are reduced. In addition, the dissipation of thermal energy from the assembly is favored. Under heavy loads, heating is thus not localized but uniformly distributed.

In some preferred embodiments, the energy storage element has at least one of the immediately following features a. and b.:
a. Metal sheets with a thickness in the range from 50 μm to 600 μm, preferably 150-350 μm, are used as contact elements.
b. The contact elements, in particular the metal sheets, consist of alloyed or unalloyed aluminum, titanium, nickel or copper, or of stainless steel (for example type 1.4303 or 1.4304) or of nickel-plated steel.

Preferably, the immediately preceding features a. and b. are realized in combination with each other.

The shape and dimension of the contact elements, in particular the metal sheets, are preferably adapted to the shape and dimension of the sides of the assembly from which the free edge strips of the current collectors are made. In preferred embodiments, the contact elements are rectangular in shape. They can thus also be easily integrated into a housing with a prismatic basic shape.

In some embodiments, contact elements, in particular metal sheets, may be used which have at least one slot and/or at least one perforation. These have the function of counteracting deformation of the contact elements during the production of the welded or soldered connection to the free edge strips of the current collectors. The contact elements can also have embossings which are intended to provide better material contact at the point of connection.

In preferred embodiments, the anode current collector and the contact element welded thereto, in particular the metal sheet welded or soldered thereto, both consist of the same material. This is preferably selected from the group comprising copper, nickel, titanium, nickel-plated steel and stainless steel.

In further preferred embodiments, the cathode current collector and the contact element welded thereto, in particular the metal sheet welded or soldered thereto, both consist of the same material. This is preferably selected from the group comprising alloyed or unalloyed aluminum, titanium and stainless steel (e.g. of type 1.4404).

Preferably, the free edge strips of the current collectors projecting from the assembly are in direct contact with the respective contact elements along their length. This preferably results in a line-shaped contact zone between the contact elements and the free edge strips.

In preferred further developments, the energy storage element thus has at least one of the immediately following features a. to c.:
a. The free edge strips of the anode current collectors are preferably in direct contact with a metallic contact element, in particular the metal sheet, along their length and are connected to this contact element, in particular this metal sheet, by welding or soldering, there being a line-shaped contact zone between the edge strips and the metallic contact element, in particular the metal sheet.
b. The free edge strips of the cathode current collectors are in direct contact with a metallic contact element, in particular a metal sheet, preferably along their length, and are connected to this contact element, in particular this metal sheet, by welding or soldering, there being a line-shaped contact zone between the edge strips and the metallic contact element, in particular the metal sheet.
c. The free edge strips of the anode current collectors and/or the free edge strips of the cathode current collectors each comprise one or more sections, each of which is continuously connected to the respective contact element, in particular the respective metal sheet, over its entire length by a weld seam or by soldering.

The immediately preceding features a. and b. can be realized both independently of each other and in combination. Preferably, features a. and b. are implemented in both cases in combination with the immediately preceding feature c.

In preferred embodiments, the energy storage element is characterized by at least one of the following features:
a. It comprises at least one contact element having an L-shaped profile.
b. It comprises at least one contact element having a U-shaped profile.
c. The contact element has an angled fastening extension.

Preferably, the immediately aforementioned features a. and c. or b. and c. are combined.

If the contact element with L-shaped profile is used, protruding edge strips of the respective current collectors can be contacted on two sides of the assembly. For this purpose, of course, it is first necessary that the electrodes of the assembly comprise two edges where their current collectors have a free edge area that is accessible to welding or soldering.

In the case of a U-shaped profile of the contact element, it is generally provided that the contacting of the protruding edges of the respective current collectors takes place on three sides of the assembly. The angled fastening extension, if provided, is primarily intended for fastening the contact element to the housing of the energy storage element, provided that the contact element is not itself part of the housing. Furthermore, the fastening extension can also be part of an L-shaped or U-shaped profile and can also be used, for example, for attaching a pole stud.

The more sides of the assembly are provided with contact elements, the better the heat dissipation properties of the energy storage element.

In some preferred embodiments, two contact elements are provided, each having an L-shaped profile, one of the contact elements being provided for electrically contacting the anodes of the assembly and the other contact element being provided for electrically contacting the cathodes of the assembly.

In preferred embodiments of the energy storage element, one of the following features may be implemented:
a. A wall of the prismatic housing serves as the contact element.
b. The contact element is electrically connected to the housing.

The realization of the immediately preceding feature a. can be particularly advantageous. While a separate contact element must additionally be connected either electrically to the housing or to the pole of a pole bushing which is insulated from the housing, this is unnecessary if the free edge strips of the current collectors are coupled directly to the housing. On the one hand, the electrodes stacked in the assembly can be even better deheated. On the other hand, the elimination of a separate arrester increases the interior space that can be used in the housing for active material, which can be used to increase the capacity.

In principle, the immediately aforementioned features a. and b. can be combined with each other. For example, the energy storage element can comprise a separate contact element which is welded or soldered to the free edge strips of the cathode current collectors, while the free edge strips of the anode current collectors are welded or soldered directly to a wall of the housing. Preferred embodiments of the housing, in particular also walls of the housing acting as contact elements, are described below.

In further preferred embodiments of the energy storage element, the following feature may be implemented:
a. The housing has at least one pole bushing, the pole bushing being in contact with the contact element.

If all current collectors of one polarity are electrically connected to the housing and all current collectors of opposite polarity are electrically connected to a contact element, the contact element can be connected to an electrical conductor of a pole bushing, for example a pole stud or a pole pin, which is led out of the housing. In this case, an electrical insulator is preferably provided to prevent electrical contact between the housing and the electrical conductor of the pole bushing. The electrical insulator can be, for example, a glass or a ceramic material or a plastic.

In other embodiments, the contact element may be welded directly to the housing.

### Preferred Embodiments of the Housing

The prismatic housing of the energy storage element preferably encloses the assembly in a gas-tight and/or liquid-tight manner. It is preferably formed from two or more metallic housing parts, for example as described in EP 3117471 B 1. The housing parts can be connected, for example, by welding.

The housing preferably comprises several rectangular side walls as well as a polygonal, in particular rectangular bottom and a polygonal, in particular rectangular upper part. In particular, the upper part and the bottom can serve as contact elements, preferably as contact plates.

In a first, preferred variant, the housing of the energy storage element has at least one of the immediately following features a. and b., preferably a combination of the two features:
a. The housing comprises a first housing part having a bottom and a plurality of side walls and an opening, and a second housing part closing the opening.
b. The contact element, in particular the contact plate, is the bottom of the first housing part.

Thus, in this embodiment, either the free edge strips of the anode current collectors or the free edge strips of the cathode current collectors are joined to the bottom of the first housing part by welding or soldering.

In a second, preferred variant, the housing of the energy storage element has at least one of the immediately following features a. and b., preferably a combination of the two features:
a. The housing comprises a first housing part having a bottom and a plurality of side walls and an opening, and a second housing part closing the opening.
b. The second housing part is the contact element.

Thus, in this embodiment, either the free edge strips of the anode current collectors or the free edge strips of the cathode current collectors are connected to the second housing part by welding or soldering.

In both variants, the first housing part preferably has a rectangular cross-section and the second housing part and the bottom of the first housing part are preferably rectangular. Both the first and the second housing part preferably consist of an electrically conductive material, in particular a metallic material. The housing parts may, for example, consist independently of a nickel-plated steel sheet or of alloyed or unalloyed aluminum.

In a preferred development of the first and second variants, the energy storage element has the immediately following features a. to e:
a. The free edge strips of the anode current collectors or the free edge strips of the cathode current collectors are connected to the first housing part by welding or soldering.
b. The energy storage element comprises a metallic contact element, in particular a metallic contact plate.
c. The current collectors not connected to the first housing part are connected to the contact element by welding or soldering.
d. The first and second housing parts are connected by welding or soldering.
e. The contact element is coupled to an electrical conductor which is led out of the housing, preferably through an aperture in the second housing part.

It is preferred that the immediately preceding features a. to e. are realized in combination with each other.

In a further preferred development of the first and second variants, the energy storage element has the immediately following features a. to e.:
a. The free edge strips of the anode current collectors or the free edge strips of the cathode current collectors are connected to the second housing part by welding or soldering.
b. The energy storage element comprises a metallic contact element, in particular a metallic contact plate.
c. The current collectors not connected to the first housing part are connected to the contact element by welding or soldering.
d. The first and second housing parts are connected by welding or soldering.
e. The contact element is coupled to an electrical conductor which is led out of the housing, preferably through an aperture in the first housing part.

It is preferred that the immediately preceding features a. to e. are realized in combination with each other.

In these developments, the housing parts are electrically connected.

In a third preferred variant, the housing of the energy storage element has at least one of the immediately following features a. and b., and preferably a combination of the two features:
a. The housing comprises a tubular first housing part having two terminal openings, a second housing part closing one of the openings, and a third housing part closing the other of the openings.
b. The contact element, in particular the contact plate, is the second housing part and/or the third housing part.

In this variant, too, the housing of the cell is prismatic. The tubular first housing part preferably has a polygonal, in particular a rectangular or hexagonal cross-section, and the second and third housing parts are correspondingly preferably also polygonal, in particular rectangular or hexagonal. Preferably, the three housing parts are connected by welding or soldering. They thus preferably have the same electrical polarity.

In a preferred development of this variant, the free edge strips of the anode current collectors or the free edge strips of the cathode current collectors are connected to the second housing part by welding or soldering. The current collectors not connected to the second housing part are connected to a separate contact element by welding or soldering. The contact element is coupled to an electrical conductor which is led out of the housing, in particular through an aperture in the first or third housing part.

Both the first and the second housing part and, if applicable, the third housing part preferably consist of an electrically conductive material, in particular a metallic material. The housing parts may, for example, consist of a nickel-plated steel sheet, stainless steel (for example of type 1.4303 or 1.4304), copper, nickel-plated copper or alloyed or unalloyed aluminum. It may also be preferred that housing parts electrically connected to the cathode consist of aluminum or an aluminum alloy, and housing parts electrically connected to the anode consist of copper or a copper alloy or nickel-plated copper.

A major advantage of this variant is that no housing parts to be produced by upstream forming and/or casting operations are required to form the housing. Instead, the tubular first housing part with a polygonal cross-section serves as the starting point.

The prismatic housings according to the above description can be particularly well filled by prismatic composite assemblies. For this purpose, the stacked electrodes of the assembly preferably have a substantially rectangular basic shape.

The housing parts are preferably sheet metal parts with a thickness in the range from 50 μm to 600 μm, preferably in the range from 150-350 μm. The sheet metal parts in turn preferably consist of alloyed or unalloyed aluminum, titanium, nickel or copper, optionally also stainless steel (for example of type 1.4303 or 1.4304) or nickel-plated steel.

### Welding or Soldering of the Contact Elements to the Current Collectors

The concept of welding the edges of current collectors with contact elements is already known from WO 2017/215900 A1 or from JP 2004-119330 A. This technology enables particularly high current carrying capacities and low internal resistance. With regard to methods for electrically connecting contact elements to the edges of current collectors, full reference is therefore made to the contents of WO 2017/215900 A1 and JP 2004-119330 A.

There are several ways in which the contact elements can be connected to the edges of the current collectors.

The contact elements can be connected to the edges along the aforementioned line-shaped contact zones via at least one weld seam. The edges can thus each comprise one or more sections, each of which is continuously connected to the contact element or elements over its entire length via a weld seam. Preferably, these sections have a minimum length of 5 mm, preferably of 10 mm, especially preferably of 20 mm.

In one possible development, the section or sections connected to the contact element continuously over their entire length extend over at least 25%, preferably over at least 50%, more preferably over at least 75%, of the total length of the respective edges of the current collectors.

In some preferred embodiments, the edges are continuously welded to the contact element along their entire length.

In further possible embodiments, the contact elements are connected to the edges of the current collectors via a plurality or plurality of welding spots.

Soldering the edges of the current collectors to a contact element can be accomplished, for example, by providing the contact element with a coating of a solder. A solder joint can be created by pressing the edges of the current collectors and the coating together and heating the contact element to a temperature that is above the melting temperature of the solder.

As is known, solder is an agent that connects metals by soldering. Generally, it is an alloy of different metals. Alloys comprising at least one metal from the group with lead, tin, zinc, silver and copper are used particularly frequently.

### Lithium Depot

The function of a lithium-ion cell is based on the availability of sufficient mobile lithium ions (mobile lithium) to balance the drawn off electric current by migration between the anode and the cathode or the negative electrode and the positive electrode. By mobile lithium is meant that the lithium is available for storage and removal processes in the electrodes during the discharge and charge processes of the lithium-ion cell or can be activated for this purpose. In the course of the discharge and charge processes of a lithium-ion cell, losses of mobile lithium occur over time. These losses occur as a result of various, generally unavoidable side reactions. Losses of mobile lithium already occur during the first charge and discharge cycle of a lithium-ion cell. During this first charge and discharge cycle, a top layer generally forms on the surface of the electrochemically active components on the negative electrode. This top layer is called the Solid Electrolyte Interphase (SEI) and generally consists of mainly electrolyte decomposition products as well as a certain amount of lithium that is tightly bound in this layer. The loss of mobile lithium associated with this process is particularly severe in cells whose anode contains portions of silicon.

In order to compensate for these losses, the energy storage element preferably has at least one of the immediately following features a. to c.:
a. The energy storage element comprises electrodes capable of reversibly accepting and releasing lithium, an organic electrolyte comprising a lithium conducting salt, and a depot of lithium or a lithium-containing material not comprised by the electrodes or electrolyte that can be used to make up for losses of mobile lithium during operation of the energy storage element.
b. The depot is in contact with the electrolyte.
c. The energy storage element has at least one electrical conductor and, if necessary, additionally at least one controllable switch via which the depot can be electrically connected to at least one of the positive or at least one of the negative electrodes of the energy storage element.

It is preferred that the immediately preceding features a. to c. are realized in combination with each other.

Expediently, the depot is preferably arranged within the housing of the energy storage element.

The electrically contactable lithium depot enables lithium to be supplied to the electrodes as required or excess lithium to be removed from the electrodes to prevent lithium plating. For this purpose, the lithium depot can be connected via the at least one electrical conductor against the negative or against the positive electrodes. Excess lithium can be fed to the lithium depot and deposited there as needed. For these applications, means can be provided which enable separate monitoring of the individual potentials of anodes and cathodes and/or external monitoring of the cell balance via electrochemical analyses such as DVA (differential voltage analysis).

The electrical conductor and the associated lithium depot are suitably electrically insulated from the positive and negative electrodes and components electrically coupled thereto.

The lithium or lithium-containing material of the lithium depot may be, for example, metallic lithium, a lithium metal oxide, a lithium metal phosphate, or other materials familiar to the skilled person.

### Other Preferred Embodiments of the Energy Storage Element.

In some preferred embodiments, the housing of the energy storage element is cuboidal in shape and is characterized by side lengths in the range from 0.5 cm to 200 cm.

The nominal capacity of the energy storage element is preferably up to 100 Ah.

In the European Union, manufacturers are strictly regulated in providing information on the nominal capacities of secondary batteries. For example, information on the nominal capacity of secondary nickel-cadmium batteries must be based on measurements according to the IEC/EN 61951-1 and IEC/EN 60622 standards, information on the nominal capacity of secondary nickel-metal hydride batteries must be based on measurements according to the IEC/EN 61951-2 standard, information on the nominal capacity of secondary lithium batteries must be based on measurements according to the IEC/EN 61960 standard, and information on the nominal capacity of secondary lead-acid batteries must be based on measurements according to the IEC/EN 61056-1 standard. Any information on nominal capacities in the present application is preferably also based on these standards.

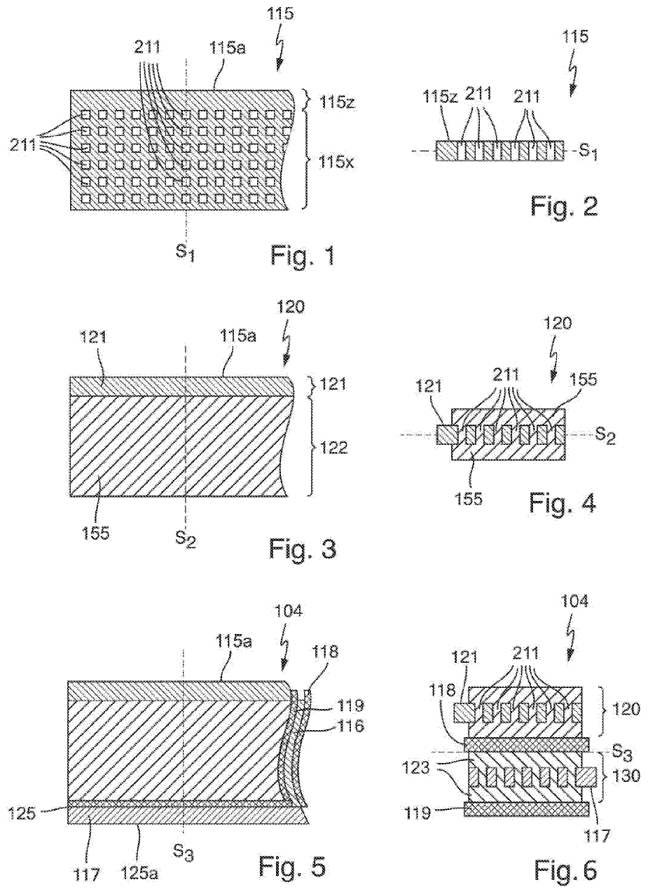

FIG. 1 and FIG. 2 illustrate the design of a current collector 115, which may be part of an electrode of an energy storage element. FIG. 2 is a sectional view along S1. The current collector 115 comprises a plurality of apertures 211, which are rectangular holes. The region 115x is characterized by the apertures 211, whereas no apertures are found in the region 115z along the longitudinal edge 115a. Therefore, the current collector 115 has a significantly lower weight per unit area in the region 115x than in the region 115z.

FIG. 3 and FIG. 4 illustrate an anode 120 fabricated by applying a negative electrode material 155 to both sides of the current collector 115 shown in FIG. 1 and FIG. 2. FIG. 4 is a sectional view along S2. The current collector 115 now has a main region 122 loaded with a layer of the negative electrode material 123, and a free edge strip 121 extending along the longitudinal edge 115a which is not loaded with the electrode material 155. Furthermore, the electrode material 155 also fills the apertures 211.

FIG. 5 and FIG. 6 illustrate the simplest case of an electrochemical cell 104 fabricated using the anode 120 shown in FIG. 3 and FIG. 4. In addition, it comprises cathode 130 and separators 118 and 119. FIG. 6 is a sectional view along S3. The cathode 130 builds on the same current collector design as the anode 120. Preferably, the current collectors 115 and 125 of the anode 120 and cathode 130 differ only in their respective material choices. For example, the current collector 125 of cathode 130 comprises a main region 116 loaded with a layer of positive electrode material 123, and a free edge strip 117 extending along longitudinal edge 125a that is not loaded with electrode material 123. The cell 104 may be combined with additional electrodes and separators to an assembly 105, such as may be included in an energy storage element 100.

In some preferred embodiments, the free edge strips 117 and 121 are coated on both sides and at least in some areas with an electrically insulating support material, for example a ceramic material such as silicon oxide or aluminum oxide. The cathode current collector 125 may be formed of aluminum, for example, and the active material coating 123 thereon may be formed of NMCA (lithium nickel manganese cobalt aluminum oxide), for example. The anode current collector 115 may be formed of copper, for example, and the active material coating 155 thereon may be a mixture of graphite and silicon, for example.

It is worth mentioning that separators 118 and 119 can be replaced by layers of solid state electrolytes depending on the electrochemical system used.

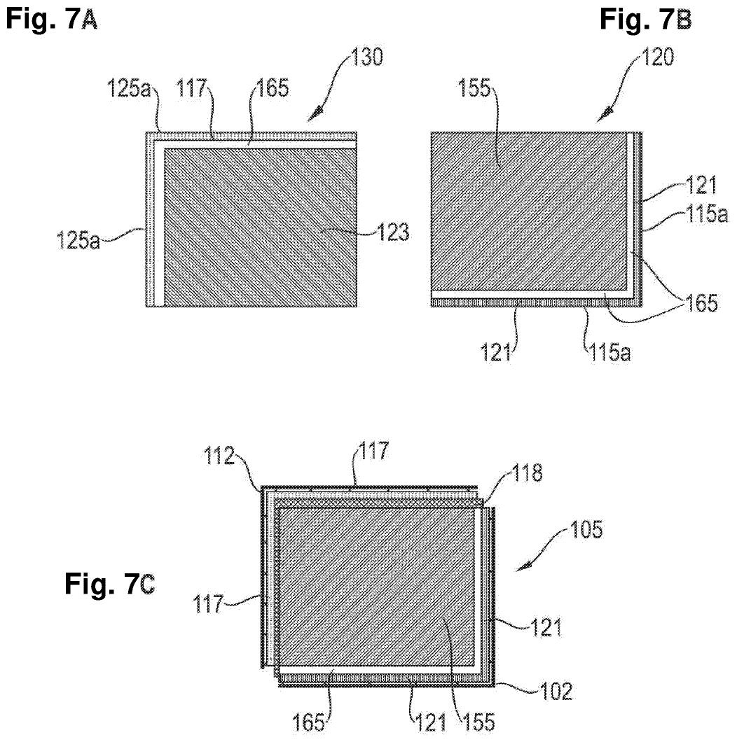

FIGS. 7A, 7B, and 7C illustrate the structure of an assembly 105.

FIG. 7A shows a cathode 130 having a rectangular base shape. Like the cathode shown in FIG. 6, it comprises a cathode current collector coated in a main region 116 with a positive electrode material 123, wherein along two adjacent sides of the cathode 130 an edge strip 117 is free of the electrode material 123. However, a ceramic coating 165 is provided as a support material in a striped sub-region of the edge strip 117. The two side edges 125a of the cathode current collector along which the ceramic coating 165 is applied are not covered by the support material.

FIG. 7B shows an anode 120 having a rectangular base shape. Like the anode shown in FIG. 6, it comprises an anode current collector which is coated in a main region 122 with a negative electrode material 155, an edge strip 121 being free of the electrode material 155 along two adjacent sides of the anode 120. A ceramic coating 165 is likewise provided as a support material in a striped sub-region of the edge strip 121. However, the two side edges 115a along which the ceramic coating 165 is applied are not covered by the support material.

FIG. 7C shows an assembly 105 formed using the anode 120 and cathode 130 according to FIG. 7A and FIG. 7B. The anode 120 and the cathode 130 are the two top electrodes in the composite body, and further electrodes below them are not visible in the top view. In the composite body, electrodes of the same polarity are formed identically in each case. A separator 118 is arranged between the anode 120 and the cathode 130.

The anode 120 and the cathode 130 of the individual cells each have the same size. They are each slightly offset from each other so that the edges 125a of the cathode current collector protrude from two adjacent sides of the assembly and the edges 115a of the anode current collector protrude from two other adjacent sides of the assembly 105. Contact elements 102 and 112 are welded to these sides. The two contact elements 102 and 112 each have an L-shaped cross-section.

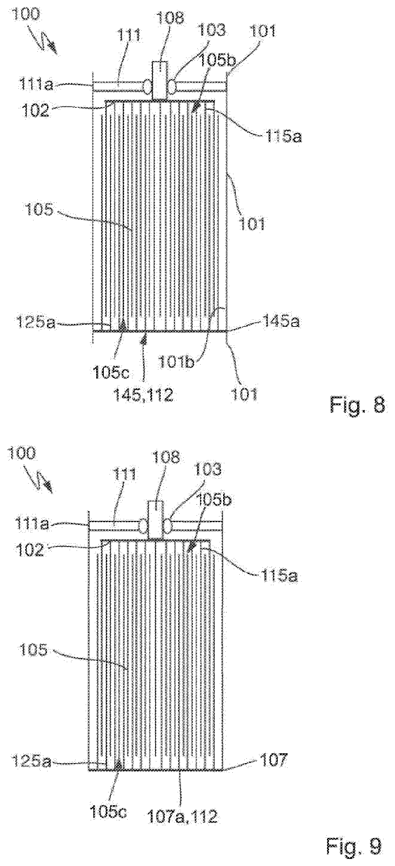

The energy storage element 100 shown in FIG. 8 comprises the prismatic assembly 105, which has six rectangular sides and is inserted axially into the tubular housing part 101, which has a rectangular cross section. Terminally, the housing part 101 has two rectangular openings into which the rectangular housing part 111 and the rectangular housing part 145 are inserted. Ideally, the housing parts 111 and 145 both consist of metal in whole or in part. The edges 111a and 145a of the housing parts 111 and 145 are connected to the housing part 101 by welding so that the housing parts 101, 110 and 145 form a liquid-tight housing.

The assembly 105 is formed from a plurality of rectangular electrodes. The electrodes each comprise a current collector, the current collectors of the negative electrodes being loaded with a layer of a negative electrode material and the current collectors of the positive electrodes being loaded with a layer of a positive electrode material. The longitudinal edges 115a of the anode current collectors protrude from the side 105b of the assembly 105, which is located above. Protruding from the bottom side 105c of the assembly 105 are the longitudinal edges 125a of the cathode current collectors.

A metal sheet, which serves as a contact element 102, rests directly on the longitudinal edges 115a of the anode current collectors. It is connected to the longitudinal edges 115a by welding.

The energy storage element 100 further comprises the metallic pole pin 108, which is welded to the contact element 102 and extends out of the housing of the energy storage element 100 through a central aperture in the housing part 111. The pole pin 108 is electrically insulated from the housing part 111 by means of the insulating means 103.

The longitudinal edge 125a of the cathode current collector abuts directly against the inner (upper) side of the housing part 145. The longitudinal edge 125a is connected to the housing part 145 by welding. The welding can be effected, for example, by welding through the housing part 145 by means of a laser. The housing part 145 functions here as a second contact element 112.

The energy storage element 100 shown in FIG. 9 comprises the prismatic assembly 105, which has six rectangular sides and is axially inserted into the housing part 107. The housing part 107 comprises the rectangular shaped bottom 107a and has a rectangular cross-section. At the upper end, the housing part 107 has a rectangular opening into which the rectangular housing part 111 is inserted. The housing parts 107 and 111 ideally both consist of metal in whole or in part. The edge 111a of housing part 111 is connected to housing part 107 by welding, so that housing parts 107 and 111 form a fluid-tight housing.

The assembly 105 is formed of a plurality of cells of rectangular electrodes. The electrodes each comprise a current collector, the current collectors of the negative electrodes being loaded with a layer of a negative electrode material and the current collectors of the positive electrodes being loaded with a layer of a positive electrode material. The longitudinal edges 115a of the anode current collectors protrude from the side 105b of the assembly 105, which is located above. Protruding from the bottom side 105c of the assembly 105 are the longitudinal edges 125a of the cathode current collectors.

A metal sheet, which serves as a contact element 102, rests directly on the longitudinal edges 115a of the anode current collectors. It is connected to the longitudinal edges 115a by welding.

The energy storage element 100 further comprises the metallic pole pin 108, which is welded to the contact element 102 and extends out of the housing of the energy storage element 100 through a central aperture in the housing part 111. The pole pin 108 is electrically insulated from the housing part 111 by means of the insulating means 103.

The longitudinal edge 125a of the cathode current collector abuts directly against the inner (upper) side of the bottom 107a. The longitudinal edge 125a is connected to the bottom 107a by welding. The welding can be effected, for example, by welding through the bottom 107a by means of a laser. The bottom 107a functions here as a second contact element 112.

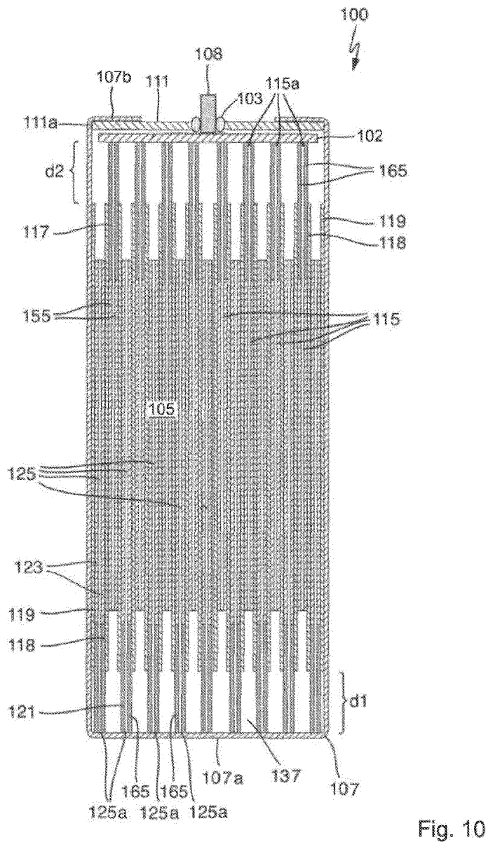

The energy storage element 100 shown in FIG. 10 comprises a housing part 107 that comprises a rectangular bottom 107a and has a rectangular cross-section, and a circular opening (defined by the edge 101a). The housing part 107 is a deep drawn part. At the upper end, the housing part 107 has a rectangular opening into which the rectangular housing part 111 is inserted. The housing parts 107 and 111 ideally both consist of metal in whole or in part. The edge 111a of housing part 111 is connected to housing part 107 by welding, so that housing parts 107 and 111 form a fluid-tight housing. The edge 107a of the housing part 101 is bent inwardly about 90° over the edge 111a of the housing part 111. The housing part 107, together with the housing part 111, encloses an interior space 137 in which the composite assembly 105 is disposed.

The prismatic assembly 105 has six rectangular sides and is formed from a plurality of rectangular electrodes and separators (exemplified by separators 118 and 119). The electrodes each comprise a current collector. The longitudinal edges of the separators form two sides of the assembly 105 from which the current collectors (115 and 125) protrude. The corresponding protrusions are labeled d1 and d2. The longitudinal edges 115a of the anode current collectors protrude from the side 105b of the assembly 105, which is located at the top here. Protruding from the bottom side 105c of the assembly 105 are the longitudinal edges 125a of the cathode current collectors.

The anode current collectors 115 are each loaded in a main region with a layer of a negative electrode material 155. The cathode current collectors 125 are each loaded in a main region with a layer of a positive electrode material 123. The anode current collectors 115 each have an edge strip 121 extending along their longitudinal edges 115a that is not loaded with the electrode material 155. Instead, each has a coating 165 of a ceramic support material applied thereto to stabilize the current collectors in the region. The cathode current collectors 125 each have an edge strip 117 extending along their longitudinal edges 125a, which is not loaded with the electrode material 123. Instead, the coating 165 of the ceramic support material is applied in each case as well.

A metal sheet, which serves as a contact element 102, rests directly on the longitudinal edges 115a of the anode current collectors. It is connected to the longitudinal edges 115a by welding.

The energy storage element 100 further comprises the metallic pole pin 108, which is welded to the contact element 102 and extends out of the housing of the energy storage element 100 through a central aperture in the housing part 111. The pole pin 108 is electrically insulated from the housing part 111 by means of the insulating means 103.

The longitudinal edges 125a of the cathode current collectors abut directly against the inner (upper) side of the bottom 107a. The longitudinal edges 125a are connected to the bottom 107a by welding. The welding can be effected, for example, by welding through the bottom 107a by means of a laser. The bottom 107a functions here as a second contact element 112.

The positive electrodes comprised by the assembly 105 may comprise, for example, 95 wt % NMCA, 2 wt % of an electrode binder, and 3 wt % carbon black as a conductive agent.

In preferred embodiments, the negative electrodes comprised by the assembly 105 may comprise, for example, 70% by weight silicon, 25% by weight graphite, 2% by weight of an electrode binder, and 3% by weight carbon black as a conductive agent.

For example, a 2 M solution of LiPF₆ in THF/mTHF (1:1) or a 1.5 M solution of LiPF₆ in FEC/EMC (3:7) with 2 wt % vinylene carbonate (VC) can be used as the electrolyte.

The current collectors, and in particular the anode current collectors 115, may have a plurality of apertures. These may be, for example, square or round holes. Preferably, the apertures are located only in the regions of the current collectors that are coated with active material. The edge regions that are not coated with active material preferably do not have apertures. The current collectors are therefore characterized by a significantly lower weight per unit area in the region with the apertures. When the current collectors are coated with the active material, the active materials can also be deposited in the apertures and can therefore be applied in larger quantities.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: An energy storage element, comprising:
an assembly comprising:
a plurality of anodes, each respective anode of the plurality of anodes comprising an anode current collector having a main region loaded with a layer of negative electrode material and a free edge strip, which is not loaded with the negative electrode material, extending along an edge, and
a plurality of cathodes, each respective cathode comprising a cathode current collector having a main region loaded with a layer of positive electrode material and a free edge strip, which is not loaded with the positive electrode material, extending along an edge,
wherein the anodes and the cathodes are stacked and are separated by separators or layers of a solid state electrolyte;
a prismatic housing enclosing the assembly; and
a contact element connected to a set of respective free edge strips by welding or soldering, the set of respective free edge strips including the free edge strips of the anode current collectors of the free edge strips of the cathode current collectors,
wherein the free edge strips of the anode current collectors protrude from one side of the assembly and the free edge strips of the cathode current collectors protrude from another side of the assembly.

2: The energy storage element of claim 1, wherein:
the anodes and the cathodes are polygonal in shape, and/or
the assembly has a prismatic shape.

3: The energy storage element of claim 1, wherein:
the assembly comprises at least one contact element having an L-shaped profile, and/or
the assembly comprises at least one contact element having a U-shaped profile.

4: The energy storage element according to claim 1, wherein:
the contact element is a wall of the prismatic housing, and/or
the contact element is electrically connected to the prismatic housing.

5: The energy storage element according to claim 1, wherein the housing has at least one pole bushing, the pole bushing being electrically connected to the contact element.

6: The energy storage element according to claim 1, wherein the energy storage element comprises a solid state electrolyte between the anodes and the cathodes.

7: The energy storage element according to claim 1, wherein:
the free edge strips of the anode current collectors and/or the free edge strips of the cathode current collectors are coated with a support material.

8: The energy storage element of claim 7, wherein at least one of:
the support material is a non-metallic material;
the support material is an electrically insulating material;
the non-metallic material is a ceramic material, a glass-ceramic material or a glass; and/or
the ceramic material is aluminum oxide (Al₂O₃), titanium oxide (TiO₂), titanium nitride (TiN), titanium aluminum nitride (TiAlN), a silicon oxide, in particular silicon dioxide (SiO₂), or titanium carbonitride (TiCN).

9: The energy storage element of claim 7, wherein at least one of:
the free edge strips of the anode current collectors and/or the free edge strips of the cathode current collectors each comprise a first sub-region coated with the support material and a second sub-region that is uncoated;
each respective first sub-region and each respective second sub-region of a respective current collector have a shape of a line or a strip and run parallel to each other; and/or
each respective first sub-region is located between a respective main region of the respective current collector and the respective second sub-region of the respective current collector.

10: The energy storage element of claim 7, wherein each respective free edge strip of a respective anode current collector and/or of a respective cathode current collector is coated with the support material up to a first edge of the respective current collector.

11: The energy storage element according to claim 1, wherein the separators comprise at least one inorganic material configured to improve resistance to thermal stress.

12: The energy storage element of claim 11, wherein the at least one inorganic material is included as a particulate filler material in the separators.

13: The energy storage element of claim 11, wherein at least one inorganic material is present as a coating on a surface of the separators.

14: The energy storage element of claim 11, wherein at least one of:
the at least one inorganic material is or comprises an electrically insulating material;
the at least one inorganic material is or comprises at least one material selected from the group consisting of ceramic material, glass-ceramic material, and glass;
the at least one inorganic material is or comprises a lithium ion conducting ceramic material;
the at least one inorganic material is or comprises an oxidic material; and/or
the ceramic or oxide material is aluminum oxide (Al₂O₃), titanium oxide (TiO₂), titanium nitride (TiN), titanium aluminum nitride (TiAlN), a silicon oxide or titanium carbonitride (TiCN).

15: The energy storage element of claim 11, wherein at least one of the following:
the separators comprise the at least one inorganic material only in regions;
the separators have an edge strip along at least one of their edges in which they comprise the at least one inorganic material as a coating and/or as a particulate filler material; and/or
the separators have a main area in which they are free of the at least one inorganic material.
